(19) United States
(12) Patent Application Publication
(10) Pub. No.: US 2026/0167018 A1
(43) Pub. Date: Jun. 18, 2026

(54) VEHICLE WHEEL CONTROL SYSTEM, A WHEEL CONTROLLER OF A VEHICLE, AND A VEHICLE HAVING THE SAME

(71) Applicants: HYUNDAI MOTOR COMPANY, Seoul (KR); KIA CORPORATION, Seoul (KR)

(72) Inventor: Soo Hyuk Lee, Hwaseong-si (KR)

(73) Assignees: HYUNDAI MOTOR COMPANY, Seoul (KR); KIA CORPORATION, Seoul (KR)

(21) Appl. No.: 19/225,670

(22) Filed: Jun. 2, 2025

(30) Foreign Application Priority Data
Dec. 18, 2024 (KR) 10-2024-0189679

(51) Int. Cl. B60L 15/20; B60K 1/00; B60L 7/22

(52) U.S. Cl. CPC B60L 15/2009; B60L 7/22; B60K 2001/006

(57) ABSTRACT

A vehicle wheel control system includes an in-wheel motor mounted on a wheel of a vehicle and configured to provide independent driving of the wheel of the vehicle. The vehicle wheel control system also includes an electronic brake configured to generate braking force on the wheel of the vehicle. The vehicle wheel control system additionally includes an integrated wheel controller configured to control the in-wheel motor and the electronic brake and a bus line connected between a vehicle controller and the integrated wheel controller and configured to transmit and receive data. The vehicle wheel control system further includes a power line supplying direct current (DC) power from a battery of the vehicle to the integrated wheel controller.

### CROSS-REFERENCE TO RELATED APPLICATION(S)

This application claims the benefit of and priority to Korean Patent Application No. 10-2024-0189679, filed on Dec. 18, 2024, the entire contents of which are hereby incorporated herein by reference.

### BACKGROUND

### 1. Field

The present disclosure relates to a vehicle wheel control system, a wheel controller of a vehicle, and a vehicle including the same.

### 2. Description of Related Art

Eco-friendly vehicles such as hybrid cars, electric cars, and fuel cell vehicles are equipped with motor drive systems for driving and power generation.

An in-wheel system is a motor drive system that comprise a structure in which a motor is installed on each driving wheel of the vehicle. The in-wheel system may independently control the driving and braking power of the four wheels of the vehicle by installing a motor on each wheel and distributing the drive without using a large drive motor.

Since the in-wheel system directly drives the wheels with the motor installed on the wheel without going through multiple power devices, it not only has less power loss, but also has the advantage of significantly reducing the use of parts, reducing the weight of the vehicle body, and improving fuel efficiency.

The in-wheel system may have a great synergy effect when combined with the vehicle's safety devices, and for example, may be combined with Electronic Stability Control (ESC), a vehicle attitude control device, to greatly improve the turning angle that allows the driver to control the vehicle as intended on a curved road.

In addition, the in-wheel system may create a flat interior space, allowing for more freedom in vehicle design.

However, in a vehicle with an in-wheel system, if the device controlling the in-wheel motor and the device controlling the braking mechanism are installed on the wheel side as separate structures, interference between the devices may occur on the wheel side, and there is a problem that performance is reduced due to restrictions on the size of some parts.

The matters described in this Background section are only intended to enhance understanding of the background of the present disclosure. Therefore, the Background section may contain information that does not form prior art that is already known to those having ordinary skill in the art to which the present disclosure pertains.

### SUMMARY

Embodiments of the present disclosure provide a vehicle wheel control system, a wheel controller of a vehicle, and a vehicle including the same, that may independently perform driving and braking control for a plurality of wheels of a vehicle.

Embodiments of the present disclosure provide an integrated wheel controller that may be easily mounted on the wheel side and may reduce complexity of an internal structure of a vehicle.

Embodiments of the present disclosure provide a vehicle wheel control system, a wheel controller of a vehicle, and a vehicle including the same, in which manufacturing costs may be reduced by reducing the number of wirings between a chassis and a wheel, and Electromagnetic Compatibility (EMC) performance of the vehicle may be improved by applying a DC power line.

Embodiments of the present disclosure provide a vehicle wheel control system, a wheel controller of a vehicle, and a vehicle including the same, in which additional energy dissipation may be implemented by performing heat exchange with an energy dissipation circuit of a power line using a cooling line of an in-wheel motor, and a brake size may be reduced.

Therefore, according to embodiments of the present disclosure, a vehicle wheel control system, a wheel controller of a vehicle, and a vehicle including the same may be provided.

According to an aspect of the present disclosure, a vehicle wheel control system is provided. The vehicle wheel control system includes an in-wheel motor mounted on a wheel of a vehicle and configured to provide independent driving of the wheel of the vehicle. The vehicle wheel control system also includes an electronic brake configured to generate braking force on the wheel of the vehicle. The vehicle wheel control system additionally includes an integrated wheel controller configured to control the in-wheel motor and the electronic brake. The vehicle wheel control system further includes a bus line connected between a vehicle controller and the integrated wheel controller and configured to transmit and receive data. The vehicle wheel control system additionally includes a power line supplying DC power from a battery of the vehicle to the integrated wheel controller.

According to another aspect of the present disclosure, a wheel controller is provided. The wheel controller includes a wheel drive control unit configured to control an in-wheel motor mounted on a wheel among a plurality of wheels included in the vehicle and configured to provide independent driving of the wheel. The wheel controller also includes a wheel braking control unit configured to control an electronic brake generating braking force on the one wheel and a receiving unit configured to receive a control signal from a vehicle controller of the vehicle. The wheel controller additionally includes a power supply unit configured to be supplied with DC power from a battery of the vehicle. The wheel controller further includes a control unit configured to control the wheel drive control unit and the wheel braking control unit based on the control signal.

According to yet another aspect of the present disclosure, a vehicle is provided. The vehicle includes a battery, a vehicle controller, a plurality of wheel units, a particular wheel unit including an in-wheel motor and an electronic brake. The vehicle further includes a plurality of integrated wheel controllers provided to correspond to the plurality of wheel units, where a particular integrated wheel controllers that corresponds to the particular wheel unit is configured to control the in-wheel motor and the electronic brake. The vehicle also includes a bus line connected between the vehicle controller and the plurality of integrated wheel controllers and configured to transmit and receive data and a power line supplying DC power from the battery to the plurality of integrated wheel controllers.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram illustrating a vehicle including a vehicle wheel control system according to an embodiment;

FIG. 2 is a schematic diagram illustrating a vehicle including a vehicle wheel control system according to an embodiment;

FIG. 3 is a schematic diagram illustrating a portion of a vehicle including a vehicle wheel control system according to an embodiment;

FIG. 4 is a schematic diagram illustrating a portion of a vehicle including a vehicle wheel control system according to another embodiment;

FIG. 5 is a schematic diagram illustrating a portion of a vehicle including a vehicle wheel control system according to another embodiment; and

FIG. 6 is a block diagram of a computing device that may fully or partially implement a vehicle wheel control system according to an embodiment.

### DETAILED DESCRIPTION

Hereinafter, embodiments are described in detail with reference to the accompanying drawings. The following detailed description is provided to enhance a comprehensive understanding of the methods, devices, and/or systems described in this specification. However, this is merely an example and the present disclosure is not limited thereto.

In describing embodiments, where it was determined that a detailed description of known technologies related to the present disclosure may unnecessarily obscure the gist of the present disclosure, the detailed description thereof has been omitted. In addition, the terms described below are terms defined in consideration of their functions in the present disclosure and may vary depending on the intention or custom of the user or operator, or the like. Therefore, the definitions should be made based on the contents throughout this specification. The terms used in the detailed description are only for the purpose of describing embodiments and do not limit the present disclosure. Unless clearly used otherwise, expressions in the singular form include plural meanings. In this description, expressions such as “including”, “having”, “provided”, or the like are intended to refer to certain features, numbers, steps, operations, elements, parts or combinations thereof, and should not be construed to exclude the presence or possibility of one or more other features, numbers, steps, operations, elements, parts or combinations thereof other than those described.

In addition, throughout the specification, when a part is said to be “connected” with or to another part, this includes not only cases where the part is “directly connected” with or to the other part, but also includes cases where the part is “indirectly connected” with or to the other part with one or more other elements therebetween.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

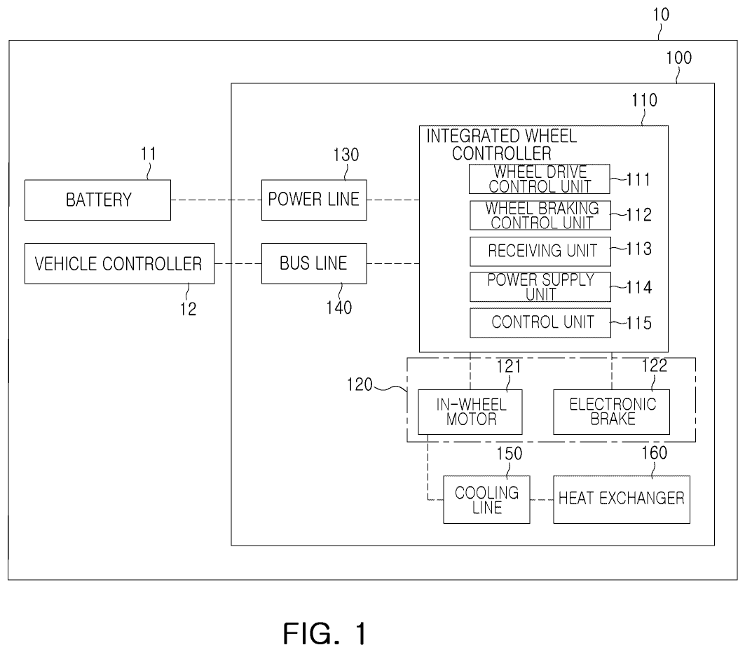

FIG. 1 schematically illustrates a vehicle including a vehicle wheel control system according to an embodiment. Referring to FIG. 1, a vehicle 10 may include a battery 11, a vehicle controller 12, and a vehicle wheel control system 100.

The battery 11 may include a rechargeable or dischargeable secondary battery. The vehicle 10 may be a hybrid vehicle or an electric vehicle that drives a motor using power supplied from the battery 11.

In addition, the battery 11 may supply power to other components included in the vehicle 10. For example, the battery 11 may supply power to and operate a display, an input module, a communication module, a sensor module, a memory, and a processor included in the vehicle 10.

The vehicle 10 may further include one or more sensors. The one or more sensors may be installed inside or outside the vehicle 10 and may detect information related to the state of the vehicle 10 or the driving situation of the vehicle 10.

The one or more sensors may include at least one of, for example, a wheel speed sensor for detecting the speed of the wheels of the vehicle 10, a vehicle speed sensor for detecting the driving speed of the vehicle 10, an accelerator pedal position sensor (APS) linked to the operation of the accelerator pedal, a brake pedal sensor (BPS) linked to the operation of the brake pedal, a steering angle sensor (SAS) linked to the operation of the steering wheel, a temperature sensor for detecting the temperature inside or outside the vehicle 10, an image sensor for obtaining image data inside or outside the vehicle 10, and a distance sensor for measuring the distance from the vehicle 10 to an obstacle located in a particular direction.

The vehicle controller 12 may receive information related to the state of the vehicle 10 or the driving situation of the vehicle 10 from the one or more sensors.

The vehicle controller 12 may transmit and receive data with other components of the vehicle 10 wirelessly or in a wired manner.

The vehicle controller 12 may generate signals for controlling various components for controlling the starting, power, braking, steering, and shifting of the vehicle 10 based on at least one of the information detected by one or more sensors and/or data transmitted from other components.

The vehicle controller 12 may transmit the generated signals to other components included in the vehicle 10. For example, the vehicle controller 12 may transmit a wheel torque command signal to an integrated wheel controller 110 included in the vehicle wheel control system 100.

The vehicle wheel control system 100 may include an integrated wheel controller 110, a wheel unit 120, a power line 130, and a bus line 140.

The integrated wheel controller 110 may be mounted on the wheel side of the vehicle 10 and may control the braking and driving of the wheel.

The wheel unit 120 may include an in-wheel motor 121 and an electronic brake 122.

The in-wheel motor 121 may be mounted on the wheel of the vehicle 10 and may provide independent driving of the wheel. The electronic brake 122 may generate braking force on the wheel of the vehicle 10.

The integrated wheel controller 110 may control the in-wheel motor 121 and the electronic brake 122. The integrated wheel controller 110 may include a wheel drive control unit 111, a wheel braking control unit 112, a receiving unit 113, a power supply unit 114, and a control unit 115.

The wheel drive control unit 111 may control the driving torque of the in-wheel motor 121. The wheel drive control unit 111 may include a first inverter circuit for controlling the in-wheel motor 121. At least a portion of the DC power may be converted into AC power by the first inverter circuit and provided to the in-wheel motor 121.

The wheel braking control unit 112 may control the braking torque of the motor included in the electronic brake 122. The wheel braking control unit 112 may include a second inverter circuit for controlling the electronic brake 122. At least a portion of the DC power may be converted into AC power by the second inverter circuit and provided to the electronic brake 122.

The receiving unit 113 may receive a control signal from the vehicle controller 12. For example, the receiving unit 113 may receive a wheel torque command signal from the vehicle controller 12.

The power supply unit 114 may receive DC power from the battery 11.

The control unit 115 may control the wheel drive control unit 111 and the wheel braking control unit 112 based on the control signal of the vehicle controller 12.

For example, the control unit 115 may derive the driving torque of the in-wheel motor 121 and the braking torque of the electronic brake 122 based on the wheel torque command signal.

The control unit 115 may distribute the driving torque and braking torque of the vehicle to implement the safety function of the vehicle based on, for example, the status and driving situation information of the vehicle 10.

The control unit 115 may control the wheel drive control unit 111 based on the derived driving torque of the in-wheel motor 121. The control unit 115 may control the wheel braking control unit 112 based on the derived braking torque of the electronic brake 122.

The power line 130 may be connected between the battery 11 and the integrated wheel controller 110. The power line 130 may supply DC power from the battery 11 to the integrated wheel controller 110.

The integrated wheel controller 110 may convert DC power into AC power and may supply the converted power to either the in-wheel motor 121 or the electronic brake 122.

In an embodiment, the integrated wheel controller 110 may further include a voltage conversion unit. The voltage conversion unit may include a DC-DC converter.

The DC-DC converter may convert the voltage level of the DC power supplied through the power line 130 based on the specifications of the electronic brake 122. The DC-DC converter may thus be configured to covert a first voltage level of the DC power supplied through the power line 130 to a second voltage level to be supplied to the electronic brake 122. For example, if the electronic brake 122 is designed to operate in a low-voltage environment, the DC-DC converter may lower the level of the DC power supplied from the battery 11.

The bus line 140 may be connected between the vehicle controller 12 and the integrated wheel controller 110. The bus line 140 may transfer (e.g., transmit and receive) data between the vehicle controller 12 and the integrated wheel controller 110.

The integrated wheel controller 110 may receive a wheel torque command signal from the vehicle controller 12 through the bus line 140. The control unit 115 of the integrated wheel controller 110 may determine (e.g., derive) the driving torque of the in-wheel motor 121 and the braking torque of the electronic brake 122 based on the wheel torque command signal.

Referring still to FIG. 1, the vehicle wheel control system 100 may further include a cooling line 150 and a heat exchanger 160.

The cooling line 150 may have a passage through which coolant for cooling the in-wheel motor 121 passes.

The heat exchanger 160 may be connected to the cooling line 150. The heat exchanger 160 may release heat absorbed by coolant passing along the passage of the cooling line 150 to the outside of the vehicle 10.

Additionally, or alternatively, the power line 130 may include an energy dissipation circuit. The energy dissipation circuit may include, for example, a brake resistor dissipating a portion of the DC power supplied to the integrated wheel controller 110 through the power line 130.

The energy dissipation circuit of the power line 130 may be disposed adjacently to at least a portion of the cooling line 150 to be capable of heat exchange with the cooling line 150.

The heat exchanger 160 may be controlled by the vehicle controller 12 to increase the amount of heat released to the outside of the vehicle 10 when energy dissipation occurs by the energy dissipation circuit of the power line 130.

In another embodiment, the power line 130 may include an energy dissipation circuit and a switching member.

The switching member may be connected to one end of the energy dissipation circuit. The switching member may be switched under the control of the integrated wheel controller 110. The switching member may determine whether the energy dissipation circuit is bypassed by switching.

For example, when the vehicle 10 is in a state in which battery charging by regenerative braking is impossible, the switching member may be switched to the energy dissipation circuit side. Accordingly, additional energy dissipation may be implemented in the vehicle 10 by dissipating some energy by the energy dissipation circuit.

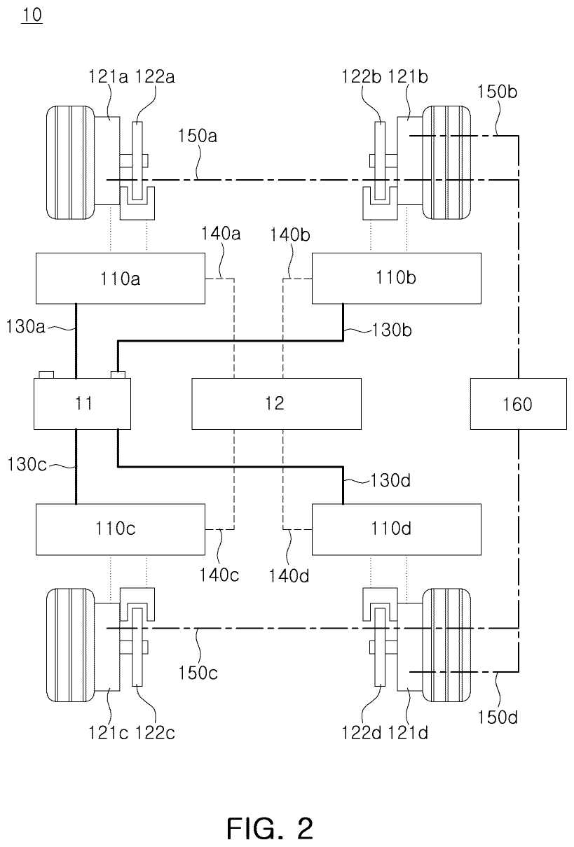

FIG. 2 schematically illustrates a vehicle including a vehicle wheel control system according to an embodiment.

As illustrated in FIG. 2, the vehicle 10 may include in-wheel motors 121a, 121b, 121c and 121d and electronic brakes 122a, 122b, 122c and 122d mounted on a plurality of wheel units.

A plurality of integrated wheel controllers 110a, 110b, 110c and 110d may be provided to correspond to the plurality of wheel units, respectively. A plurality of integrated wheel controllers 110a, 110b, 110c and 110d may control corresponding in-wheel motors 121a, 121b, 121c and 121d and electronic brakes 122a, 122b, 122c and 122d.

Embodiments of the present disclosure may avoid interference problems between wheels and suspension members and interference problems due to suspension behavior by mounting an integrated wheel controller that integrates control of an in-wheel motor and an electronic brake on the wheel side.

The plurality of integrated wheel controllers 110a, 110b, 110c and 110d may be connected to the battery 11 of the vehicle 10 through power lines 130a, 130b, 130c and 130d. The plurality of integrated wheel controllers 110a, 110b, 110c and 110d may receive DC power from the battery 11 through power lines 130a, 130b, 130c and 130d.

In an embodiment of the present disclosure, EMC problems caused by noise radiation inside a vehicle may be prevented by limiting a flow of AC waveform current in a wire between a chassis side and an integrated wheel controller.

The plurality of integrated wheel controllers 110a, 110b, 110c and 110d may be connected to the vehicle controller 12 through bus lines 140a, 140b, 140c and 140d. The plurality of integrated wheel controllers 110a, 110b, 110c and 110d may transmit and receive data with the vehicle controller 12 through bus lines 140a, 140b, 140c and 140d.

The vehicle 10 may further include cooling lines 150a, 150b, 150c and 150d for cooling the in-wheel motors 121a, 121b, 121c and 121d. The cooling lines 150a, 150b, 150c and 150d may have paths through which coolant passes.

The cooling lines 150a, 150b, 150c and 150d may be connected to the heat exchanger 160. The heat exchanger 160 may release heat absorbed by the coolant of the cooling lines 150a, 150b, 150c and 150d to the outside of the vehicle 10.

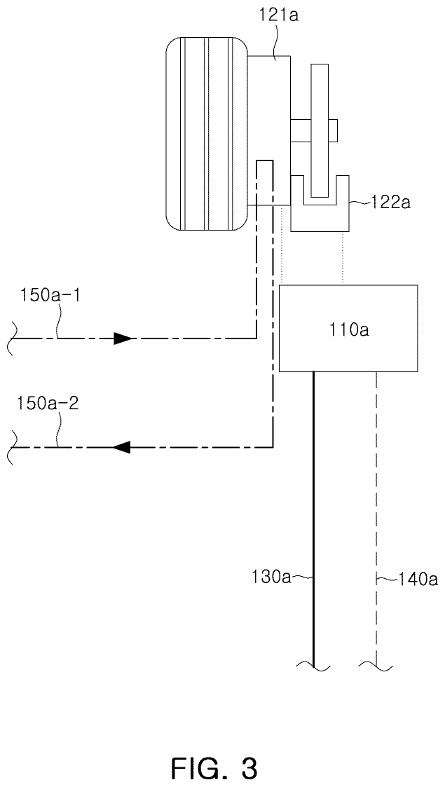

FIG. 3 illustrates a portion of the vehicle 10 illustrated in FIG. 2, according to an embodiment. As illustrated in FIG. 3, the integrated wheel controller 110a is disposed on the wheel side and may control the in-wheel motor 121a and the electronic brake 122a.

The integrated wheel controller 110a may receive DC power from the vehicle battery through the power line 130a. The integrated wheel controller 110a may include one or more inverter circuits that convert the DC power into AC power.

The integrated wheel controller 110a may receive a control signal from the vehicle controller 12 through the bus line 140a.

The integrated wheel controller 110a may receive a wheel torque command signal from the vehicle controller 12 and may control the driving torque of the in-wheel motor 121a and the braking torque of the electronic brake 122a based on the wheel torque command signal.

The integrated wheel controller 110a may control the in-wheel motor 121a based on the driving torque of the in-wheel motor 121a. In addition, the integrated wheel controller 110a may control the braking torque of the motor included in the electronic brake 122a based on the braking torque of the electronic brake 122a.

The cooling lines 150a-1 and 150a-2 may have a passage through which coolant for cooling the in-wheel motor 121a passes. The heat of the in-wheel motor 121a may be absorbed by the low-temperature coolant introduced through the cooling line 150a-1, and the coolant that has absorbed the heat may be transferred to the heat exchanger through the cooling line 150a-2.

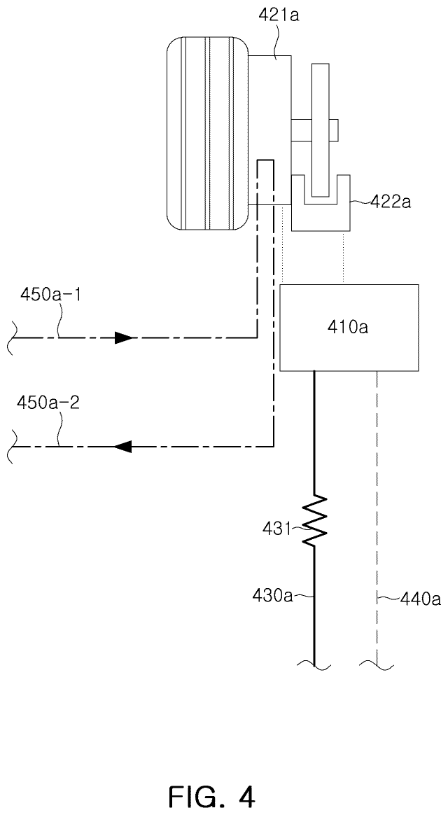

FIG. 4 illustrates a portion of the vehicle 10 illustrated in FIG. 2, according to another embodiment. Descriptions of the same configuration as those illustrated in FIG. 3 have been omitted.

In the embodiment of FIG. 4, a power line 430a that supplies DC power to an integrated wheel controller 410a may include an energy dissipation circuit 431. The energy dissipation circuit 431 may include a brake resistor dissipating a portion of the DC power supplied to the integrated wheel controller 410a through the power line 430a.

The energy dissipation circuit 431 may be disposed adjacently to at least a portion of the cooling lines 450a-1, 450a-2 to be capable of heat exchange with each other.

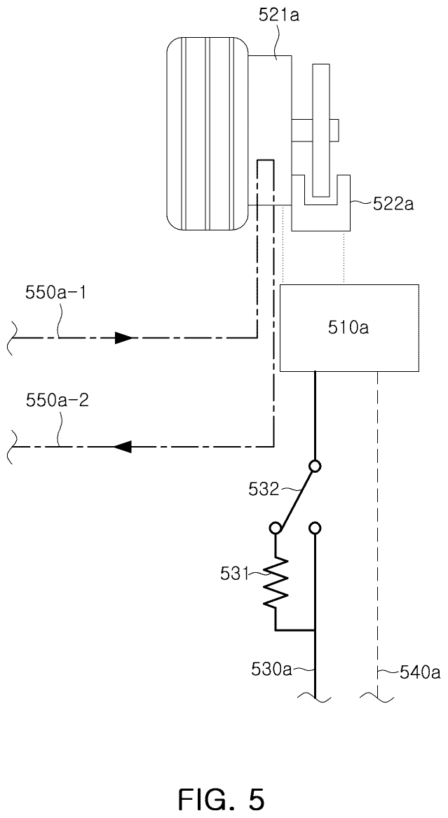

FIG. 5 illustrates a portion of the vehicle 10 illustrated in FIG. 2, according to yet another embodiment. Descriptions of the same configurations as those illustrated in FIGS. 3 and 4 have been omitted.

In the embodiment of FIG. 5, a power line 530a that supplies DC power to an integrated wheel controller 510a may include an energy dissipation circuit 531 and a switching member 532.

The energy dissipation circuit 531 may include a brake resistor dissipating a portion of the DC power supplied to the integrated wheel controller 510a through the power line 530a.

The energy dissipation circuit 531 may be disposed adjacently to at least a portion of the cooling lines 550a-1 and 550a-2 to be capable of heat exchange with the cooling lines 550a-1 and 550a-2.

The switching member 532 may be connected to one end of the energy dissipation circuit 531. Whether the energy dissipation circuit 531 is bypassed may be determined by switching the switching member 532.

For example, when the vehicle is in a state in which battery charging by regenerative braking is impossible, the switching member 532 may be switched to the energy dissipation circuit 531. Accordingly, additional energy dissipation may be implemented in the vehicle by the energy dissipation circuit 531.

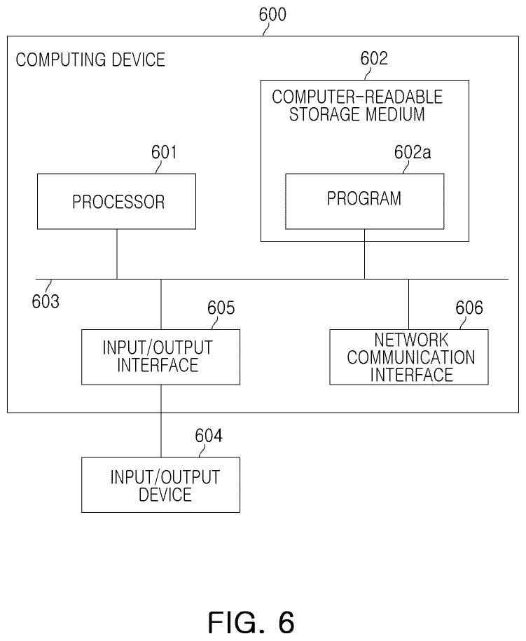

FIG. 6 is a block diagram of a computing device 600 that may fully or partially implement a vehicle wheel control system 100 according to an embodiment, and may include all or part of the vehicle wheel control system 100 illustrated in FIG. 1.

As illustrated in FIG. 6, the computing device 600 includes at least one processor 601, a computer-readable storage medium 602, and a communication bus 603.

The processor 601 may cause the computing device 600 to operate according to the example embodiments mentioned above. For example, the processor 601 may execute one or more programs stored in the computer-readable storage medium 602. The one or more programs may include one or more computer-executable instructions, and the computer-executable instructions may be configured to cause the computing device 600 to perform operations according to the example embodiments when executed by the processor 601.

The computer-readable storage medium 602 is configured to store computer-executable instructions or program code, program data, and/or other suitable forms of information. The program 602a stored on the computer-readable storage medium 602 includes a set of instructions executable by the processor 601. In an embodiment, the computer-readable storage medium 602 may be memory (volatile memory such as random access memory, nonvolatile memory, or a suitable combination thereof), one or more magnetic disk storage devices, optical disk storage devices, flash memory devices, or any other form of storage medium that may be accessed by the computing device 600 and may store desired information, or a suitable combination thereof.

The communication bus 603 interconnects the processor 601, the computer-readable storage medium 602, and other various components of the computing device 600.

The computing device 600 may also include one or more input/output interfaces 605 that provide interfaces for one or more input/output devices 604 and one or more network communication interfaces 606. The input/output interfaces 605 and the network communication interfaces 606 are connected to the communication bus 603.

The network communication interface 606 may be an interface for communication within the vehicle or for communication between the vehicle and other devices outside the vehicle, and may include, for example, a Controller Area Network (CAN), a Media Oriented Systems Transport (MOST) network, a Local Interconnect Network (LIN), and/or X-by-Wire (Flexray), Wi-Fi, Bluetooth, NFC, RFID, etc. The network may be a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or another cellular network.

The input/output device 604 may be connected to other components of the computing device 600 via an input/output interface 605. Examples of the input/output device 604 may include input devices such as pointing devices (such as a mouse or trackpad), keyboards, touch input devices (such as a touchpad or touchscreen), voice or sound input devices, various types of sensor devices, and/or photographing devices, and/or output devices such as display devices, printers, speakers, and/or network cards. The example input/output device 604 may be included in the computing device 600 as a component that constitutes the computing device 600, or may be connected to the computing device 600 as a separate device distinct from the computing device 600.

Embodiments of the present disclosure may include programs (e.g., in the form of computer-readable instructions) for performing the methods described in this specification on a computer, and a computer-readable recording medium (e.g., a non-transitory computer-readable recording medium) including the program. The computer-readable recording medium may include program commands, local data files, local data structures, or the like alone or in combination. The medium may be those designed and configured specifically for the embodiments of the present disclosure, or may be those commonly available in the field of computer software. Examples of the computer-readable recording medium include magnetic media such as hard disks, floppy disks, and magnetic tapes, optical recording media such as CD-ROMs and DVDs, and hardware devices specifically configured to store and execute program commands such as ROMs, RAMs, and flash memories. Examples of the program may include not only machine language codes such as those generated by a compiler, but also high-level language codes that may be executed by a computer using an interpreter, or the like.

As set forth above, according to embodiments of the present disclosure, there may be provided a vehicle wheel control system, a wheel controller of a vehicle, and a vehicle including the same, that may independently perform driving and braking control for a plurality of wheels of a vehicle.

According to an embodiment, an integrated wheel controller that may be easily mounted on the wheel side, thereby providing a reduced complexity of an internal structure of a vehicle.

According to embodiments, there may be provided a vehicle wheel control system, a wheel controller of a vehicle, and a vehicle including the same, in which manufacturing costs may be reduced by reducing the number of wirings between a chassis and a wheel, and Electromagnetic Compatibility (EMC) performance of the vehicle may be improved by applying a DC power line.

According to embodiments, there may be provided a vehicle wheel control system, a wheel controller of a vehicle, and a vehicle including the same, in which additional energy dissipation may be implemented by performing heat exchange with an energy dissipation circuit of a power line using a cooling line of an in-wheel motor, and a brake size may be reduced.

While example embodiments have been shown and described above, it should be apparent to those having ordinary skill in the art to which the present disclosure pertains that modifications and variations could be made without departing from the scope of the present disclosure as defined by the appended claims.

What is claimed is:

1. A vehicle wheel control system comprising:
an in-wheel motor mounted on a wheel of a vehicle, the in-wheel motor configured to provide independent driving of the wheel of the vehicle;
an electronic brake configured to generate braking force on the wheel of the vehicle;
an integrated wheel controller configured to control the in-wheel motor and the electronic brake;
a bus line connected between a vehicle controller and the integrated wheel controller, the bus line configured to transmit and receive data; and
a power line configured to supply direct current (DC) power from a battery of the vehicle to the integrated wheel controller.

2. The vehicle wheel control system of claim 1, wherein the integrated wheel controller includes:
a wheel drive control unit configured to control a driving torque of the in-wheel motor; and
a wheel braking control unit configured to control a braking torque of the motor included in the electronic brake.

3. The vehicle wheel control system of claim 2, wherein:
the wheel drive control unit includes a first inverter circuit configured to control the in-wheel motor; and
the wheel braking control unit includes a second inverter circuit configured to control the electronic brake.

4. The vehicle wheel control system of claim 2, wherein the integrated wheel controller is configured to:
receive a wheel torque command signal from the vehicle controller through the bus line; and
determine the driving torque of the in-wheel motor and the braking torque of the electronic brake based on the wheel torque command signal.

5. The vehicle wheel control system of claim 1, wherein the integrated wheel controller further includes a DC-DC converter configured to convert a first voltage level of the DC power received through the power line to a second voltage level to be supplied to the electronic brake.

6. The vehicle wheel control system of claim 1, further comprising a cooling line having a passage through which a coolant for cooling the in-wheel motor passes.

7. The vehicle wheel control system of claim 6, wherein the power line includes an energy dissipation circuit, wherein the energy dissipation circuit is disposed adjacently to at least a portion of the cooling line to be capable of heat exchange with the cooling line.

8. The vehicle wheel control system of claim 7, wherein the energy dissipation circuit includes a brake resistor configured to dissipate a portion of the DC power supplied to the integrated wheel controller through the power line.

9. The vehicle wheel control system of claim 7, wherein the power line further includes a switching member connected to an end of the energy dissipation circuit, and wherein the switching member is configured to be switched to determine whether the energy dissipation circuit is bypassed.

10. The vehicle wheel control system of claim 9, wherein the switching member is configured to be switched toward the energy dissipation circuit when the vehicle is in a state in which the battery is not charged by regenerative braking.

11. The vehicle wheel control system of claim 9, further comprising a heat exchanger connected to the cooling line and configured to dissipate heat absorbed by the coolant to an outside of the vehicle,
wherein the heat exchanger is controlled to increase an amount of heat released in connection with an occurrence of energy dissipation by the energy dissipation circuit.

12. A wheel controller comprising:
a wheel drive control unit configured to control an in-wheel motor mounted on a wheel among a plurality of wheels included in a vehicle, wherein the in-wheel motor is configured to provide independent driving of the wheel;
a wheel braking control unit configured to control an electronic brake generating braking force on the wheel;
a receiving unit configured to receive a control signal from a vehicle controller of the vehicle;
a power supply unit configured to be supplied with DC power from a battery of the vehicle; and
a control unit configured to control the wheel drive control unit and the wheel braking control unit based on the control signal.

13. The wheel controller of claim 12, wherein:
the wheel drive control unit includes a first inverter circuit configured to control the in-wheel motor; and
the wheel braking control unit includes a second inverter circuit configured to control the electronic brake.

14. The wheel controller of a vehicle of claim 13, wherein:
the receiving unit is configured to receive a wheel torque command signal from the vehicle controller; and
the control unit is configured to control a driving torque of the in-wheel motor and a braking torque of the electronic brake based on the wheel torque command signal.

15. The wheel controller of a vehicle of claim 12, further comprising a voltage conversion unit configured to convert a first voltage level of the DC power to a second voltage level to be supplied to the electronic brake.

16. A vehicle comprising:
a battery;
a vehicle controller;
a plurality of wheel units, wherein a particular wheel unit among the plurality of wheel units includes an in-wheel motor and an electronic brake;
a plurality of integrated wheel controllers provided to correspond to the plurality of wheel units, wherein a particular integrated wheel controller that corresponds to the particular wheel unit is configured to control the in-wheel motor and the electronic brake;
a bus line connected between the vehicle controller and the plurality of integrated wheel controllers, the bus line configured to transmit and receive data; and
a power line configured to supply DC power from the battery to the plurality of integrated wheel controllers.

17. The vehicle of claim 16, wherein the particular integrated wheel controller among the plurality of integrated wheel controllers includes:
a wheel drive control unit configured to control a driving torque of the in-wheel motor; and
a wheel braking control unit configured to control a braking torque of a motor included in the electronic brake.

18. The vehicle of claim 16, further comprising:
a cooling line having a passage through which a coolant for cooling the in-wheel motor passes; and
a heat exchanger connected to the cooling line, the heat exchanger configured to release heat absorbed by the coolant to an outside of the vehicle.

19. The vehicle of claim 18, wherein the power line includes an energy dissipation circuit,
wherein the energy dissipation circuit is disposed adjacently to at least a portion of the cooling line to be capable of heat exchange with the cooling line.

20. The vehicle of claim 19, wherein the power line further includes a switching member connected to an end of the energy dissipation circuit, and wherein the switching member is configured to be switched to determine whether the energy dissipation circuit is bypassed.
